(19) United States
(12) Patent Application Publication
(10) Pub. No.: US 2026/0128196 A1
(43) Pub. Date: May 7, 2026

(54) CLAMP ATTACHMENT DEVICE AND CLAMP ATTACHMENT METHOD

(71) Applicant: Yazaki Corporation, Tokyo (JP)

(72) Inventors: Hiromasa NAKAJIMA, Shizuoka (JP); Takahiro ISHIZAWA, Shizuoka (JP)

(73) Assignee: Yazaki Corporation, Tokyo (JP)

(21) Appl. No.: 19/439,707

(22) Filed: Jan. 5, 2026

Related U.S. Application Data
(63) Continuation of application No. PCT/JP2024/024342, filed on Jul. 5, 2024.

(30) Foreign Application Priority Data
Aug. 9, 2023 (JP) 2023-129909

(51) Int. Cl. H01B 13/012; B60R 16/02

(52) U.S. Cl. CPC H01B 13/01281; H01B 13/01209; H01B 13/01236; B60R 16/0215

(57) ABSTRACT

A clamp attachment device includes: a first chuck for clamping and holding a cable clamp; a chuck movement section for moving the first chuck and thereby overlapping the cable clamp with one or more component electric wires; a second chuck for clamping and holding the cable clamp and the one or more component electric wires together while they are overlapped with each other; and a taping section for winding a tape around the cable clamp held by the first chuck, wherein the taping section further winds the tape around the cable clamp and the one or more component electric wires starting from a taped portion while the cable clamp and the one or more component electric wires are held by the second chuck, wherein the tape has been wound around the cable clamp in the taped portion.

### BACKGROUND OF THE INVENTION

### Technical Field

The present invention relates to a clamp attachment device and a clamp attachment method for attaching a cable clamp to one or more component electric wires of a wire harness.

### Background Art

Conventionally, wire harnesses for use e.g. in an automobile are often equipped with a cable clamp for fixing the wire harness to an attachment position, such as a vehicle body panel. Some of such cable clamps are of a type which includes a clamp portion in an intermediate location of a belt portion of the cable clamp in a longitudinal direction of the belt portion (see e.g. Patent Document 1). Many cable clamps of this type are overlapped with the one or more component electric wires of the wire harness so that the belt portion extends along a wire length direction of the one or more component electric wires, wherein the cable clamp is then fixed to the one or more component electric wires by means of taping.

### Citation List

### Patent Literature

Patent Document 1: JP 2010-073328 A

### SUMMARY OF THE INVENTION

In many cases, such fixation of the cable clamp to the one or more component electric wires of the wire harness by means of taping is performed manually by an operator. Such manual fixation of the cable clamp by means of taping tends to impose burden on the operator. Although automated fixation is thus desired, the fixing operation itself is complicated, and therefore, no specific approach is currently proposed for the automation.

Therefore, the present invention is focused on the above-mentioned problem, and an objective of the present invention is to provide a clamp attachment device and a clamp attachment method which enable a cable clamp to be automatically attached to one or more component electric wires of a wire harness.

In order to achieve the above objective, a clamp attachment device includes: a first chuck configured to hold a cable clamp by clamping it on a first end side of a belt portion of the cable clamp in a width direction of the belt portion, the cable clamp including a clamp portion at an intermediate location of the belt portion along a longitudinal direction of the belt portion, wherein the clamp portion is configured to be attached to a predetermined attachment position and the belt portion is configured to fixed to one or more component electric wires of a wire harness to extend along a wire length direction of the one or more component electric wires so that the wire harness is fixed to the attachment position; a chuck movement section configured to move the first chuck holding the cable clamp to position the cable clamp so that the belt portion extends along the wire length direction and the cable clamp overlaps with the one or more component electric wires; a second chuck configured to be placed adjacent to the first chuck on the first end side and clamp and hold the cable clamp and the one or more component electric wires together in an overlapping direction which have been transitioned into an overlapped state with each other by the chuck movement section, wherein the cable clamp and the one or more component electric wires are overlapped with each other in the overlapping direction; and a taping section configured as a mechanism which winds a tape around the belt portion of the cable clamp on a second end side of the belt portion while it is held by the first chuck, wherein during moving the first chuck by the chuck movement section, the taping section is configured to be moved together with the first chuck while the tape remains wound around the cable clamp, wherein after the movement, the taping section is configured to wind the tape around the cable clamp and the one or more component electric wires starting from a taped portion while the cable clamp and the one or more component electric wires are held by the second chuck, with the tape having been wound around the belt portion in the taped portion.

In order to achieve the above objective, a clamp attachment method is carried out by using the above-described clamp attachment device and includes: a first chucking step of clamping and holding the belt portion of the cable clamp on the first end side by the first chuck; a first taping step of winding the tape around the belt portion of the cable clamp on the second end side by the taping section while the belt portion is held by the first chuck; a chuck movement step of moving the first chuck by the chuck movement section while holding the cable clamp by the first chuck so that the cable clamp overlaps with the one or more component electric wires, wherein during moving the first chuck, the taping section is moved together with the first chuck while the tape remains wound around the cable clamp; after movement by the chuck movement section, a second chucking step of clamping and holding the cable clamp and the one or more component electric wires by the second chuck; and a second taping step of winding the tape around the cable clamp and the one or more component electric wires starting from the taped portion while the cable clamp and the one or more component electric wires are held by the second chuck.

The above-described clamp attachment device and clamp attachment method enable a cable clamp to be automatically attached to one or more component electric wires of a wire harness.

### BRIEF DESCRIPTION OF THE DRAWINGS

FIG. 1 shows a perspective view of a clamp attachment device according to an embodiment;

FIG. 2 shows a perspective view of the clamp attachment device as shown in FIG. 1 in a view along a direction of arrow V11 according to FIG. 1;

FIG. 3 shows one or more component electric wires of a wire harness and a cable clamp to be processed by means of the clamp attachment device as shown in FIGS. 1 and 2;

FIG. 4 shows how the cable clamp is held by a first chuck of the clamp attachment device as shown in FIGS. 1 and 2;

FIG. 5 shows a second chuck of the clamp attachment device as shown in FIGS. 1 and 2;

FIG. 6 shows how the cable clamp and the one or more component electric wires are held by the second chuck as shown in FIG. 5;

FIG. 7 shows a schematic view illustrating how a taping section winds a tape around a belt portion of the cable clamp on a second end side of the belt portion while the cable clamp is held by the first chuck;

FIG. 8 shows a schematic view illustrating how the taping section winds the tape around the cable clamp and the one or more component electric wires in a location where the taping section has arrived after being moved together with the first chuck;

FIG. 9 shows a schematic view illustrating a series of processes of a clamp attachment method in which the cable clamp is held by the first chuck for taping and is overlapped with the one or more component electric wires of the wire harness, wherein the cable clamp is finally held by the second chuck;

FIG. 10 shows a schematic view illustrating a series of processes following a third step according to FIG. 9, wherein in this series of processes, the tape is finally wound around the cable clamp and the one or more component electric wires; and

FIG. 11 shows a series of processes following a fifth step according to FIG. 10, wherein in this series of processes, fixation of the cable clamp by means of taping is finally performed on a first end side of the cable clamp.

### DETAILED DESCRIPTION OF THE PREFERRED EMBODIMENTS

Hereinafter, embodiments of a clamp attachment device and a clamp attachment method will be described.

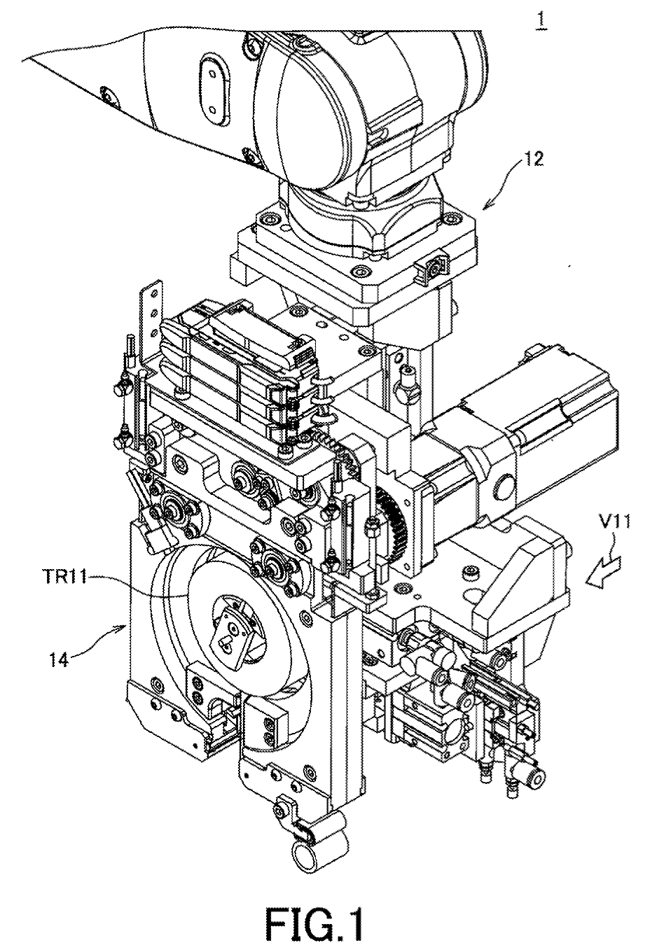

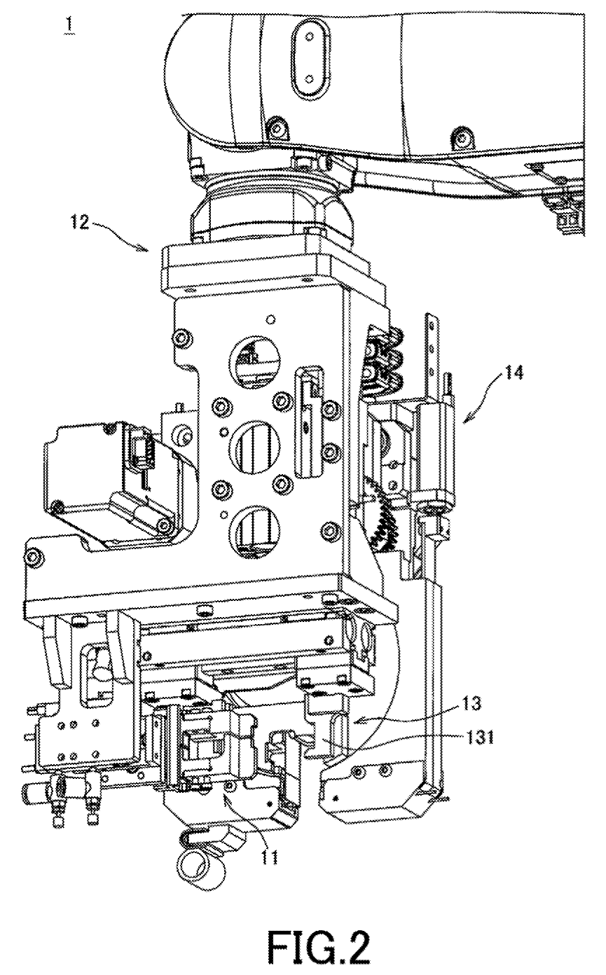

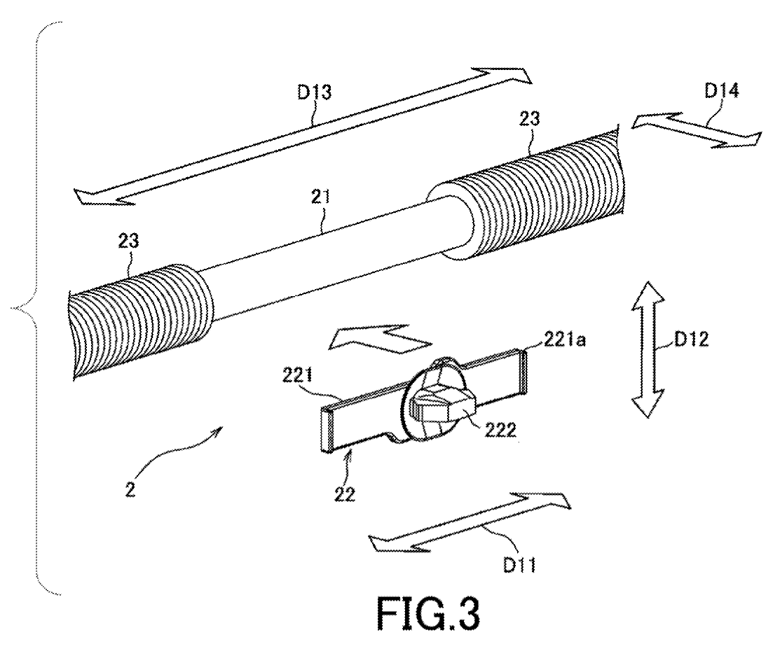

FIG. 1 shows a perspective view of a clamp attachment device according to an embodiment. FIG. 2 shows a perspective view of the clamp attachment device as shown in FIG. 1 in a view along a direction of arrow V11 according to FIG. 1. FIG. 3 shows one or more component electric wires of a wire harness and a cable clamp to be processed by means of the clamp attachment device as shown in FIGS. 1 and 2.

A clamp attachment device 1 according to the present embodiment is provided e.g. for producing wire harnesses 2 for automobiles and is configured to attach a cable clamp 22 to one or more component electric wires 21 of a wire harness 2 by taping fixation. According to the example shown in FIG. 3, the one or more component electric wires 21 of the wire harness 2 is covered with corrugated tubes 23 as outer covers, except for an area with the cable clamp 22 attached thereto. The cable clamp 22 is attached to an exposed portion of the one or more component electric wires 21 that is not covered with a corrugated tube 23. This cable clamp 22 is made of resin and has a structure where a clamp portion 222 is provided at an intermediate location of a belt portion 221 of the cable clamp 22 in its longitudinal direction D11, wherein the clamp portion 222 is configured to be attached to a predetermined attachment position such as a vehicle body panel. The clamp attachment device 1, which attaches the cable clamp 22 to the one or more component electric wires 21, includes a first chuck 11, a chuck movement section 12, a second chuck 13, and a taping section 14.

The first chuck 11 is a mechanism section that holds the cable clamp 22 by clamping it in a width direction D12 of the belt portion 221 of the cable clamp 22 on a first end 221a side of the belt portion 221.

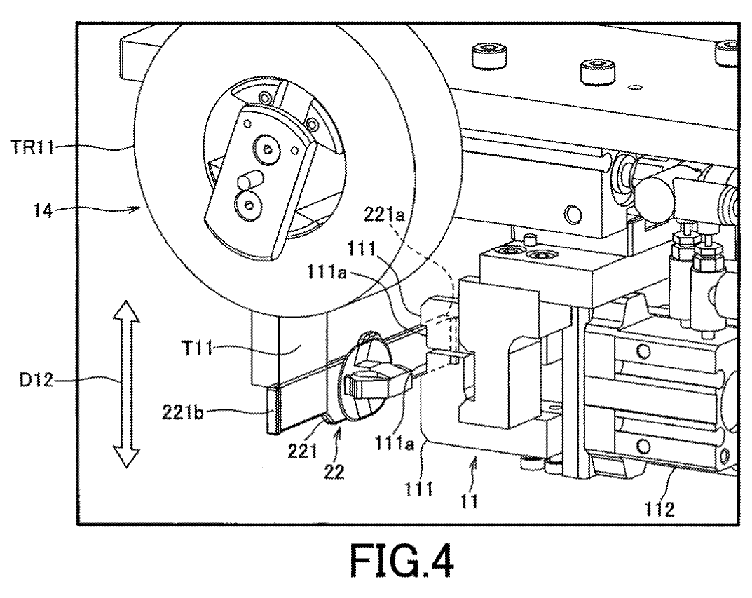

FIG. 4 shows how the cable clamp is held by a first chuck of the clamp attachment device as shown in FIGS. 1 and 2.

The first chuck 11 includes a pair of first gripping arms 111 and a first arm driving section 112 configured to drive the pair of first gripping arms 111 to be opened/closed, wherein the pair of first gripping arms 111 is capable of being opened/closed in the width direction D12 of the belt portion 221 of the cable clamp 22 to be held by the first chuck 11. A pair of clamp receiving recesses 111a is formed in gripping regions of the pair of first gripping arms 111 which serve for gripping the belt portion 221, wherein the pair of clamp receiving recesses 111a is formed to be adapted to a width and a thickness of the belt portion 221. When the pair of first gripping arms 111 is closed by the first arm driving section 112, the belt portion 221 is clamped and held by the pair of clamp receiving recesses 111a so that the belt portion 221 is accommodated in the pair of clamp receiving recesses 111a. The clamp attachment device 1 is provided such that a tape T11 is wound around the cable clamp 22 on its second end 221b side by the taping section 14 while the cable clamp 22 is held on the first end 221a side by the first chuck 11, as described below.

The chuck movement section 12 as shown in FIGS. 1 and 2 is configured as a robotic arm with the first chuck 11, the second chuck 13 and taping section 14 mounted on a tip portion of the robotic arm, wherein these portions are configured to be moved together by the robotic arm. To describe the chuck movement section 12 focusing on movement of the first chuck 11, the chuck movement section 12 acts to move the first chuck 11 holding the cable clamp 22. By moving the first chuck 11, the chuck movement section 12 positions the cable clamp 22 so that the belt portion 221 extends along the wire length direction D13 (FIG. 3) and the cable clamp 22 is overlapped with the one or more component electric wires 21. During moving the first chuck 11, the second chuck 13 and the taping section 14 are moved together.

The second chuck 13 is a mechanism section that clamps and holds the cable clamp 22 and the one or more component electric wires 21 together which have been transitioned into an overlapped state with each other by the chuck movement section 12.

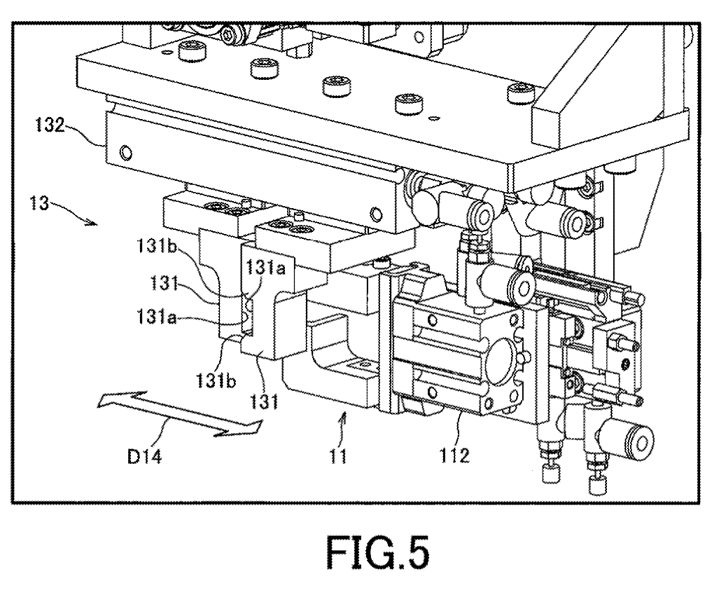

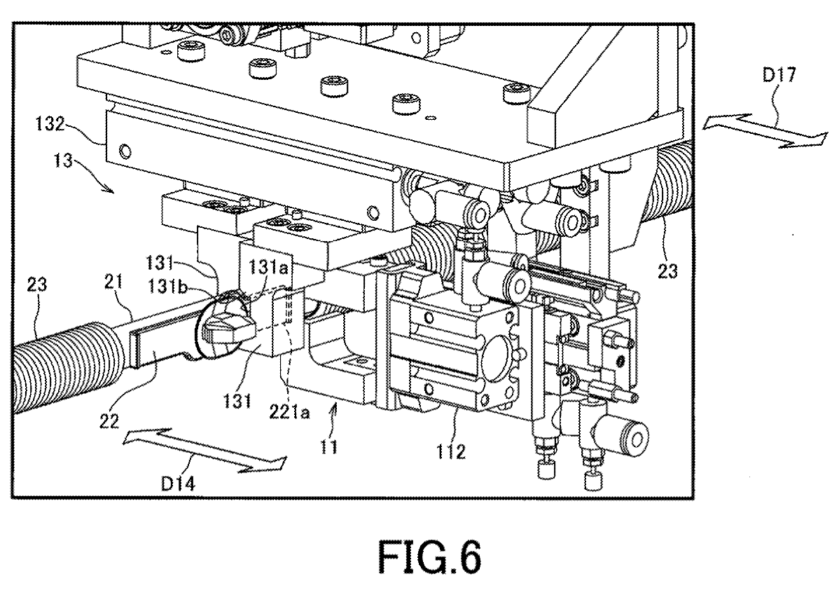

FIG. 5 shows a second chuck of the clamp attachment device as shown in FIGS. 1 and 2. FIG. 6 shows how the cable clamp and the one or more component electric wires are held by the second chuck as shown in FIG. 5.

The second chuck 13 is configured to be placed adjacent to the first chuck 11 and clamps and holds the overlapped cable clamp 22 and one or more component electric wires 21 together in an overlapping direction D14 on the first end 221a side, wherein the cable clamp 22 and the one or more component electric wires 21 are overlapped with each other in the overlapping direction D14. The second chuck 13 includes a pair of second gripping arms 131 and a second arm driving section 132 configured to drive the pair of second gripping arms 131 to be opened/closed, wherein the pair of second gripping arms 131 is capable of being opened/closed in the overlapping direction D14. It is to be noted that the view in FIG. 2 omits one of the second gripping arms 131 so that the first chuck 11 is visible which is placed adjacent to the second chuck 13. A pair of receiving recesses 131a is formed in gripping regions of the pair of second gripping arms 131 which serve for gripping the cable clamp 22 and the one or more component electric wires 21, wherein the pair of receiving recesses 131a is formed to be adapted to a thickness of a bundle of an intended number of component electric wires 21. Furthermore, each of the receiving recesses 131a is chamfered on its entrance side at a corner of the entrance section to define a wide opening 131b which is capable of receiving a thicker gripped object, for example the corrugated tube 23 as the outer cover.

The taping section 14 as shown in FIGS. 1, 2 and 4 winds the tape T11 around the belt portion 221 of the cable clamp 22 on its second end 221b side while the belt portion 221 is held by the first chuck 11 as follows.

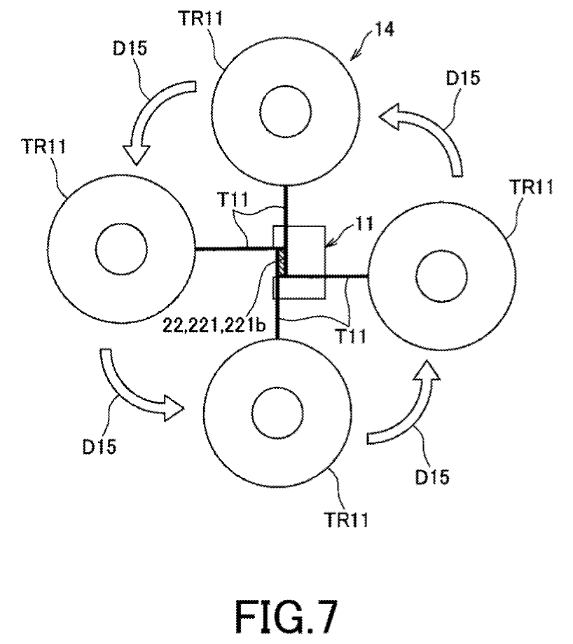

FIG. 7 shows a schematic view illustrating how a taping section winds a tape around a belt portion of the cable clamp on a second end side of the belt portion while the cable clamp is held by the first chuck.

First, the taping section 14 includes a tape reel TR11 as shown in FIGS. 1 and 4 and is a mechanism section which performs taping operation by pulling the tape T11 from the tape reel TR11. For winding the tape T11 around the second end 221b side of the belt portion 221 of the cable clamp 22 held by the first chuck 11, a pulled end of the tape T11 pulled from the tape reel TR11 is applied to the belt portion 221 on its second end 221b side. Subsequently, the taping section 14 rotates the tape reel TR11 in a peripheral direction D15 of the belt portion 221 to wind one or more turns of the tape T11 around the belt portion 221. Once the taping operation for the belt portion 221 of the cable clamp 22 is finished, the taping section 14 is moved together with the first chuck 11 by the chuck movement section 12. This means that while the first chuck 11 is moved by the chuck movement section 12 to overlap the cable clamp 22 with the one or more component electric wires 21, the taping section 14 is moved together with the first chuck 11 with the tape T11 remaining wound around the cable clamp 22. Then, the taping section 14 winds the tape T11 around the cable clamp 22 and the one or more component electric wires 21 in a location where the taping section 14 has arrived after being moved.

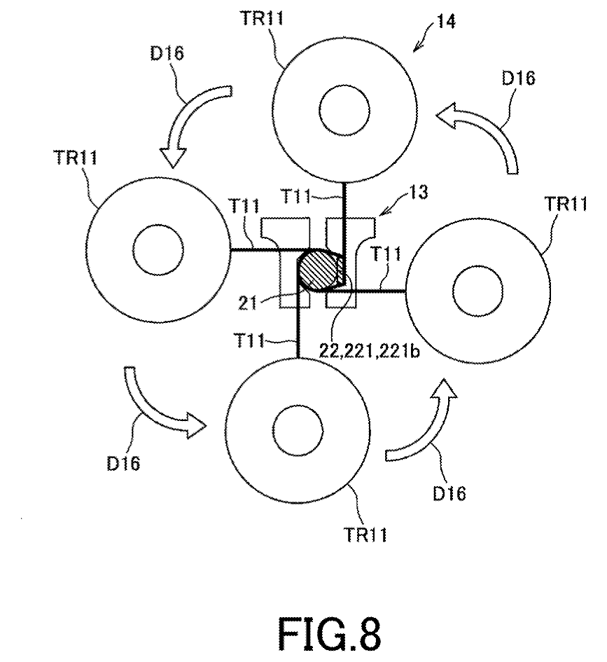

FIG. 8 shows a schematic view illustrating how the taping section winds the tape around the cable clamp and the one or more component electric wires in a location where the taping section has arrived after being moved together with the first chuck.

At the time of moving the taping section 14, the cable clamp 22 and the one or more component electric wires 21 are overlapped with each other and held by the second chuck 13, as shown in FIG. 6. At this time, the tape T11 pulled from the tape reel TR11 is wound around the belt portion 221 of the cable clamp 22 on its second end 221b side, although it is not shown in FIG. 6. Starting from this taped portion with the tape T11 wound therearound on the second end 221b side, the taping section 14 rotates the tape reel TR11 in a peripheral direction D16 of the one or more component electric wires 21 to wind one or more turns of the tape T11 around the cable clamp 22 and the one or more component electric wires 21. In this manner, the cable clamp 22 is fixed to the one or more component electric wires 21 on the second end 221b side of the belt portion 221 of the cable clamp 22 by the taping operation. Subsequently, once the taping operation is finished for the cable clamp 22 and the one or more component electric wires 21 on the second end 221b side, the taping section 14 performs tape-cutting operation, wherein the taping section 14 is then conveyed to the first end 221a side of the belt portion 221 by the chuck movement section 12. During this conveyance, the first chuck 11 and the second chuck 13 which have released the first end 221a side on the one hand and the cable clamp 22 and the one or more component electric wires 21 on the other hand are also moved together with the taping section 14. At a location they have arrived after the movement, the second chuck 13 clamps and holds the one or more component electric wires 21 via the corrugated tube 23 in a thickness direction D17 of the one or more component electric wires 21 (FIG. 6). Subsequently, the taping section 14 winds the tape T11 around the cable clamp 22 and the one or more component electric wires 21 on the first end 221a side of the belt portion 221. In this manner, the cable clamp 22 according to the present embodiment is fixed to the one or more component electric wires 21 at opposite ends of the cable clamp 22 by the taping operation at two locations, i.e., on the second end 221b side and the first end 221a side.

Next, a clamp attachment method for attaching the cable clamp 22 to the one or more component electric wires 21 of the wire harness 2 will be described which is carried out by means of the clamp attachment device 1 according to the present embodiment, although the above description may be repeated hereinafter, wherein the following description will make reference with other figures.

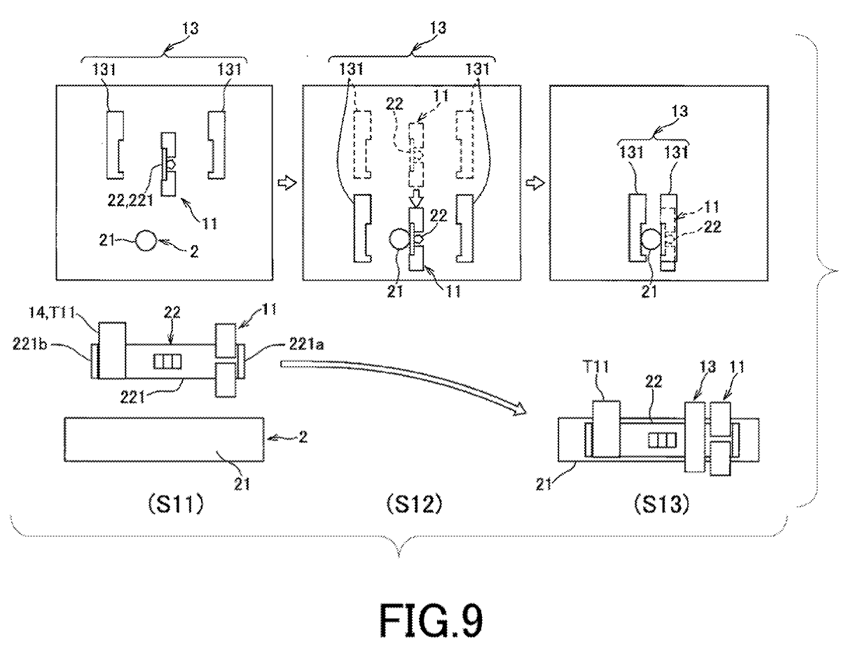

FIG. 9 shows a schematic view illustrating a series of processes of a clamp attachment method in which the cable clamp is held by the first chuck for taping and is overlapped with the one or more component electric wires of the wire harness, wherein the cable clamp is finally held by the second chuck.

First, at a first step S11 in the clamp attachment method using the clamp attachment device 1 according to the present embodiment, the cable clamp 22 is held by the first chuck 11 (first chucking step). This means that the belt portion 221 of the cable clamp 22 is clamped and held on its first end 221a side by the first chuck 11 During the first step S11, the tape T11 is next wound around the belt portion 221 of the cable clamp 22 on its second end 121b side by the taping section 14 while the cable clamp 22 is held by the first chuck 11 (first taping step). This first step S11 is performed at a location which is spaced away from the one or more component electric wires 21 of the wire harness 2. At this time, the second chuck 13 is in a state where the pair of second gripping arms 131 is opened at a location spaced away from the one or more component electric wires 21.

At a second step S12 following the first step S11, a chuck movement step is performed in which the first chuck 11 holding the cable clamp 22 is moved by the chuck movement section 12 so that the cable clamp 22 is overlapped with the one or more component electric wires 21. During the chuck movement step in the second step S12, the taping section 14 in which the tape T11 remains wound around the cable clamp 22, and the second chuck 13 with the pair of second gripping arms 131 opened are conveyed together with the first chuck 11.

At a subsequent third step S13, after being moved by the chuck movement section 12, the cable clamp 22 and the one or more component electric wires 21 are clamped and held by closing the pair of second gripping arms 131 of the second chuck 13 (second chucking step). At this third step S13, the first chuck 11 is still holding the cable clamp 22. Also, the tape T11 from the taping section 14 remains wound around the cable clamp 22.

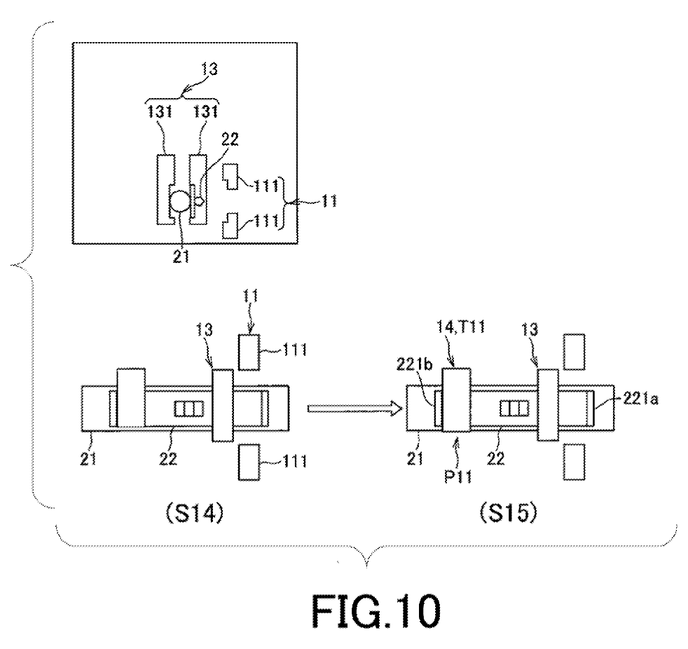

FIG. 10 shows a schematic view illustrating a series of processes following a third step according to FIG. 9, wherein in this series of processes, the tape is finally wound around the cable clamp and the one or more component electric wires.

At a fourth step S14 following the third step S13 in FIG. 9, the pair of first gripping arms 111 of the first chuck 11 is opened while the pair of second gripping arms 131 of the second chuck 13 is closed and the cable clamp 22 and one or more component electric wires 21 are held thereby. With this operation of the first gripping arms 111, the cable clamp 22 is released from the first chuck 11. At a subsequent fifth step S15, the tape T11 is wound around the cable clamp 22 and the one or more component electric wires 21 by the taping section 14 while the cable clamp 22 and the one or more component electric wires 21 are held by the second chuck 13 (second taping step). The taping operation at this fifth step S15 is performed starting from the taped portion P11 of the cable clamp 22 on its second end 221b side. With this taping operation, the cable clamp 22 is fixed to the one or more component electric wires 21 on the second end 221b side. According to the present embodiment, the fifth step S15 is followed by fixation of the cable clamp 22 on the first end 221a side by means of taping.

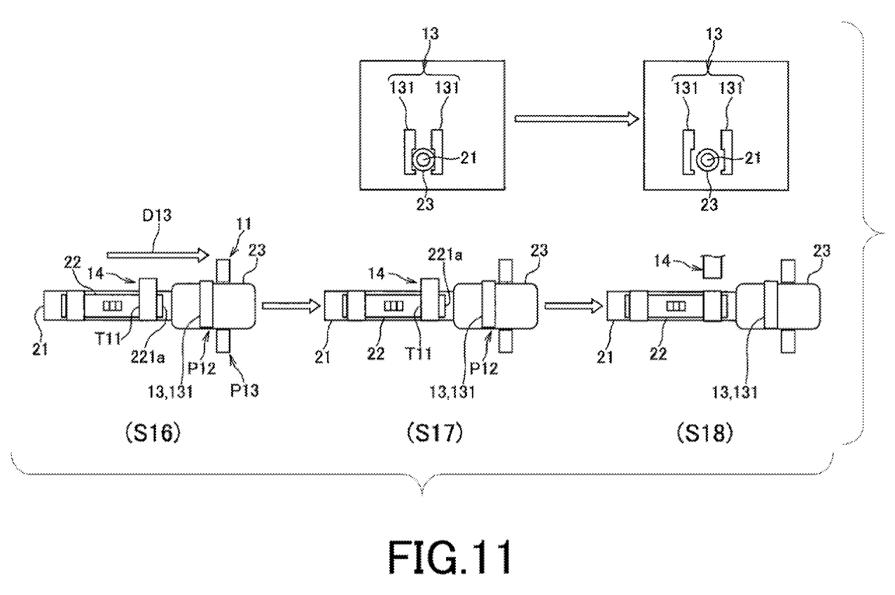

FIG. 11 shows a series of processes following a fifth step according to FIG. 10, wherein in this series of processes, fixation of the cable clamp by means of taping is finally performed on a first end side of the cable clamp.

At a sixth step S16 following the fifth step S15 in FIG. 10, the taping section 14 applies tape- cutting operation to the tape T11 for which the taping operation has been finished. Furthermore, in the second chuck 13, the pair of second gripping arms 131 is opened to release the cable clamp 22 and the one or more component electric wires 21. Subsequently, together with the already opened first chuck 11 and the taping section 14 which has performed the tape-cutting operation, the opened second chuck 13 is conveyed in the movement direction D13 to a separated position P12 by the chuck movement section 12, wherein the separated position P12 is located away from the cable clamp 22. Conveying the opened first chuck 11 together with the second chuck 13 results in retraction of the first chuck 11 to a retracted position P13 in which the first chuck 11 does not interfere with further processes. Here, the separated position P12 which is a destination for movement of the second chuck 13 is a position allowing the taping section 14 conveyed together with the second chuck 13 to perform the taping operation around the cable clamp 22 on its first end 221a side. After positioning the taping section 14 in this position, the taping section 14 pulls the tape T11 from the tape reel TR11 and applies the pulled end of the tape T11 to the first end 221a side of the cable clamp 22 to be ready for the subsequent taping operation. It is to be noted that the according to the present example, the one or more component electric wires 21 include one or more portions which are adjacent to the portion for attaching the cable clamp 22 and covered with corrugated tubes 23, wherein the separated position P12 is a position in which the corrugated tubes 23 are clamped by the pair of second gripping arms 131.

At a subsequent seventh step S17, the pair of second gripping arms 131 is closed in the separated position P12 to perform a third chucking step in which the one or more component electric wires 21 are held via the corrugated tube 23 by the second chuck 13. Simultaneously with the end of holding the one or more component electric wires 21 by the second chuck 13, a third taping step is performed in which the taping section 14 winds the tape T11 around the cable clamp 22 on its first end 221a to fix the cable clamp 22 to the one or more component electric wires 21 on this first end 221a side.

Once the third taping step in the seventh step S17 is finished, the taping section 14 performs the tape-cutting operation again in a subsequent eighth step S18. Furthermore, the pair of second gripping arms 131 is opened, and the corrugated tube 23, i.e., the one or more component electric wires 21 are released by the second chuck 13. The series of processes in the clamp attachment method ends with the tape-cutting operation and the release of the one or more component electric wires 21 at the eighth step S18 so that attachment of the cable clamp 22 to the one or more component electric wires 21 by means of taping at opposite ends of the cable clamp 22 is finished.

The clamp attachment device 1 and clamp attachment method according to the above-described embodiment enable the following effects to be achieved:

According to the present embodiment, after holding the cable clamp 22 by the first chuck 11, the tape T11 is wound around the cable clamp 22. Subsequently, the first chuck 11 and the taping section 14 are moved to align the cable clamp 22 with respect to the one or more component electric wires 21 of the wire harness 2 so that the aligned one or more component electric wires 21 and cable clamp 22 are clamped and held together by the second chuck 13. Then, by fixation of the cable clamp 22 by means of taping starting from the taped portion P11 of the cable clamp 22 with the tape T11 wound therearound, difficulties in operation, such as instability of the tape T11 during the taping fixation of the cable clamp 22 to the one or more component electric wires 21, can be overcome. By overcoming the difficulties, the cable clamp 22 is fixed to the one or more component electric wires 21 by means of taping in a stable manner. In this manner, the present embodiment enables the difficulties in operation in the case of automation to be overcome so that the cable clamp 22 can be automatically attached to the one or more component electric wires 21 of the wire harness 2.

Here, according to the present embodiment, the taping section 14 includes the tape reel TR11 and is configured to pull the tape T11 from the tape reel TR11 for taping operation. This configuration enables a longer tape T11 to be held in the taping section 14 with a reduced space for accommodating the tape T11 as compared to e.g. holding the tape T11 in the form of a long belt.

The present embodiment is further provided such that the first chuck 11 releases the cable clamp 22 after being held by the second chuck 13. Once taping operation starting from the taped portion P11 is finished, the second chuck 13 is configured to release the cable clamp 22 and the one or more component electric wires 21 and to be conveyed to the separated position P12 to hold the one or more component electric wires 21. The chuck movement section 12 is configured to retract the first chuck 11 which has released the cable clamp 22, to the predetermined retracted position P13 and to convey the second chuck which has released the cable clamp 22 and the one or more component electric wires 21, to the separated position P12. Then, upon the one or more component electric wires 21 being held by the second chuck 13 in the separated position P12, the taping section 14 is configured to wind the tape T11 around the cable clamp 22 and the one or more component electric wires 21 on the first end side 221a. According to this configuration, the taping operation is performed on both opposite end sides of the belt portion 221 of the cable clamp 22, and therefore, the attachment strength for attaching the cable clamp 22 to the one or more component electric wires 21.

According to the present embodiment, the one or more component electric wires 21 are further at least partially covered with outer covers, such as corrugated tubes 23, wherein the second chuck 13 is configured to be opened/closed to be able to perform holding operation via this outer covers. This configuration enables the degree of freedom for the holding operation by the second chuck 13 to be improved, which enables the holding operation to be effectively adapted to various gripped portions of the one or more component electric wires 21 with different thicknesses depending on the presence/absence of outer covers. Moreover, attachment of the cable clamp 22 can be effectively adapted to multiple different types of component electric wires with different thicknesses depending on the presence/absence of the outer covers.

It should be noted that the above-described embodiment merely illustrates a representative form of the clamp attachment device and clamp attachment method. The clamp attachment device and clamp attachment method are not limited to this embodiment and may be implemented in various modified forms.

For example, as examples of the clamp attachment device and clamp attachment method, the above-described embodiment shows the clamp attachment device 1 and the clamp attachment method for attaching the cable clamp 22 to the one or more component electric wires 21 of the wire harness 2 for use in an automobile. However, the clamp attachment device and clamp attachment method are not limited thereto. The wire harness for attaching the cable clamp thereto may not be provided for use in an automobile, but the clamp attachment device and the clamp attachment method may be implemented in any specific manner which allows a cable clamp to be attached to one or more component electric wires of a wire harness.

As an example of the chuck movement section, the above-described embodiment further shows the chuck movement section 12 as a robotic arm which includes the first chuck 11, the second chuck 13 and the taping section 14 mounted on a tip portion of the robotic arm, wherein these portions are configured to be moved together by the robotic arm. However, the chuck movement section is not limited thereto, but the chuck movement section may be configured to move only the first chuck, provided that the chuck movement section is configured to overlap the cable clamp with the one or more component electric wires by moving the first chuck. Alternatively, the chuck movement section may be configured to move one of the second chuck or the taping section together with the first chuck. In these cases, one or more additional movement sections may be provided for a portion(s) which is not moved by the chuck movement sections. Furthermore, the chuck movement section is not limited to a robotic arm, but may be configured in any manner with regard to a specific mechanism of the chuck movement section.

As an example of the taping section, the above-described embodiment shows the taping section 14 which includes the tape reel TR11 and configured to perform the taping operation by pulling the tape T11 from the tape reel TR11. However, the taping section is not limited thereto, but may hold the tape for example in the form of a long belt for taping operation. However, the taping section 14 that includes the tape reel TR11 enables the tape T11 to be held with a reduced accommodating space, as described above.

As examples of the clamp attachment device and clamp attachment method, the above-described embodiment further shows the clamp attachment device 1 and clamp attachment method which provide taping operation at opposite ends of the cable clamp 22. However, the clamp attachment device and clamp attachment method are not limited thereto, but may be configured to provide taping operation only at the first end side of the cable clamp. However, attachment strength of the cable clamp 22 to the one or more component electric wires 21 may be improved by applying taping operation at opposite ends of the cable clamp 22, as described above.

As an example of the second chuck, the above-described embodiment further shows the second chuck 13 that is configured to be opened/closed to allow the one or more component electric wires 21 to be held by the second chuck 13 via the outer covers such as corrugated tubes 23. However, the second chuck is not limited thereto, but may have an opening/closing structure which is limited to directly holding the one or more component electric wires. However, the second chuck 13 that is capable of holding one or more component electric wires 21 via the outer covers enables the holding operation to be adapted to the presence/absence of outer covers which may affect a gripped thickness of the component electric wires 21.

### REFERENCE SIGNS LIST

1 Clamp attachment device

2 Wire harness

11 First chuck

12 Chuck movement section

13 Second chuck

14 Taping section

21 Component electric wire(s)

22 Cable clamp

23 Corrugated tubes (outer covers)

111 First gripping arms

111a Clamp receiving recesses

112 First arm driving section

131 Second gripping arms

131a Receiving recesses

131b Wide openings

132 Second arm driving section

221 Belt portion

221a First end

221b Second end

222 Clamp portion

D11 Longitudinal direction

D12 Width direction

D13 Wire length direction

D14 Overlapping direction

D15, D16 Peripheral direction

D17 Thickness direction

P11 Taped portion

P12 Separated position

P13 Retracted position

S11 First step (first chucking step, first taping step)

S12 Second step (chuck movement step)

S13 Third step (second chucking step)

S14 Fourth step

S15 Fifth step (second taping step)

S16 Sixth step

S17 Seventh step

S18 Eighth step

T11 Tape

TR11 Tape reel

What is claimed is:

1. A clamp attachment device comprising:
a first chuck configured to hold a cable clamp by clamping it on a first end side of a belt portion of the cable clamp in a width direction of the belt portion, the cable clamp including a clamp portion at an intermediate location of the belt portion along a longitudinal direction of the belt portion, wherein the clamp portion is configured to be attached to a predetermined attachment position and the belt portion is configured to fixed to one or more component electric wires of a wire harness to extend along a wire length direction of the one or more component electric wires so that the wire harness is fixed to the attachment position;
a chuck movement section configured to move the first chuck holding the cable clamp to position the cable clamp so that the belt portion extends along the wire length direction and the cable clamp overlaps with the one or more component electric wires;
a second chuck configured to be placed adjacent to the first chuck on the first end side and clamp and hold the cable clamp and the one or more component electric wires together in an overlapping direction which have been transitioned into an overlapped state with each other by the chuck movement section,
wherein the cable clamp and the one or more component electric wires are overlapped with each other in the overlapping direction; and
a taping section configured as a mechanism which winds a tape around the belt portion of the cable clamp on a second end side of the belt portion while it is held by the first chuck,
wherein during moving the first chuck by the chuck movement section, the taping section is configured to be moved together with the first chuck while the tape remains wound around the cable clamp,
wherein after the movement, the taping section is configured to wind the tape around the cable clamp and the one or more component electric wires starting from a taped portion while the cable clamp and the one or more component electric wires are held by the second chuck, with the tape having been wound around the belt portion in the taped portion.

2. The clamp attachment device according to claim 1,
wherein the taping section includes a tape reel, and
wherein the taping section is configured to perform taping operation by pulling the tape from the tape reel.

3. The clamp attachment device according to claim 1,
wherein the first chuck is configured to release the cable clamp upon the cable clamp and the one or more component electric wires being held by the second chuck,
wherein once taping operation starting from the taped portion by the taping section is finished, the second chuck is configured to release the cable clamp and the one or more component electric wires and to be conveyed to a separated position located away from the cable clamp to clamp and hold the one or more component electric wires in its thickness direction in the separated position,
wherein the chuck movement section is configured to retract the first chuck which has released the cable clamp, to a predetermined retracted position and to convey the second chuck which has released the cable clamp and the one or more component electric wires, to the separated position,
wherein once the taping operation starting from the taped portion is finished, the taping section is configured to perform tape-cutting operation,
wherein upon the one or more component electric wires being held by the second chuck in the separated position, the taping section is configured to then wind the tape around the cable clamp and the one or more component electric wires on the first end side of the belt portion, and
wherein once the taping operation is finished, the taping section is configured to perform tape-cutting operation again.

4. The clamp attachment device according to claim 1,
wherein the one or more component electric wires are at least partially covered with a predetermined outer cover, and
wherein the second chuck is configured to be opened/closed to be able to perform holding operation via the outer cover.

5. A clamp attachment method carried out by using the clamp attachment device according to claim 1, comprising:
a first chucking step of clamping and holding the belt portion of the cable clamp on the first end side by the first chuck;
a first taping step of winding the tape around the belt portion of the cable clamp on the second end side by the taping section while the belt portion is held by the first chuck;
a chuck movement step of moving the first chuck by the chuck movement section while holding the cable clamp by the first chuck so that the cable clamp overlaps with the one or more component electric wires, wherein during moving the first chuck, the taping section is moved together with the first chuck while the tape remains wound around the cable clamp;
after movement by the chuck movement section, a second chucking step of clamping and holding the cable clamp and the one or more component electric wires by the second chuck; and
a second taping step of winding the tape around the cable clamp and the one or more component electric wires starting from the taped portion while the cable clamp and the one or more component electric wires are held by the second chuck.
